(19) United States
(12) Patent Application Publication
(10) Pub. No.: US 2026/0348089 A1
(43) Pub. Date: Nov. 5, 2026

(54) PREPARATION METHOD FOR DISTILLERS GRAIN-BASED LYOCELL FIBER PULP

(71) Applicant: SHAOXING UNIVERSITY, Shaoxing City, Zhejiang (CN)

(72) Inventors: Chi Shen, Shaoxing City (CN); Enqi Jin, Shaoxing City (CN); Xiaoxiong Zhuang, Shaoxing City (CN); Jian Mao, Shaoxing City (CN); Bojun Xi, Shaoxing City (CN)

(21) Appl. No.: 18/996,952

(22) PCT Filed: Mar. 31, 2023
(86) PCT No.: PCT/CN2023/085484

§ 371 Date: Jan. 17, 2025

(30) Foreign Application Priority Data
Sep. 6, 2022 (CN) 202211082597.X

(51) Int. Cl. D21C 3/04; D21C 1/04; D21C 1/06

(52) U.S. Cl. CPC D21C 3/04; D21C 1/04; D21C 1/06; D10B 2201/01

(57) ABSTRACT

Disclosed in the present invention is a preparation method for distillers grain-based Lyocell fiber pulp. The method comprises: sequentially drying, pulverizing, and sieving a distillers grain raw material to obtain distillers grain powder; and treating the distillers grain powder by using dilute sulfuric acid, caustic soda/sodium sulfite and p-toluenesulfonic acid aqueous solution in sequence to obtain distillers grain-based Lyocell fiber pulp. In the present invention, because distillers grains are treated by means of a treatment process of using dilute sulfuric acid, caustic soda/sodium sulfite and p-toluenesulfonic acid, the obtained distillers grain pulp cellulose has a purity of 90% or more, and can be used for preparing Lyocell fibers.

### BACKGROUND OF THE INVENTION

### 1. Field of the Invention

The inventive disclosure relates to the technical field textile raw material preparation, and in particular to a preparation method of distillers grain-based Lyocell fiber pulp.

### 2. Description of the Prior Art

Lyocell fiber (English name is Lyocell fiber) is a regenerated cellulose fiber produced through wet spinning using N-methylmorpholine N-oxide (NMMO) as a solvent. In 1980, the German company Akzo-Nobel first obtained the production process and product patent for Lyocell fiber, and in 1989 it was officially named by the Comité International de la Rayonne et des Fibres Synthétiques. Lyocell fiber has a short production cycle, and its production process is pollution-free (the recovery rate of the solvent, NMMO, can reach 99.7%). The textile products made from it have high strength and good wearing performance, its waste is biodegradable, earning it the reputation as the “green fiber of the 21st century.”

In China's Lyocell fiber industrial production, to meet the high dissolubility requirements of the spinning pulp and the high quality requirements of the spinning solution, the vast majority of Lyocell fiber spinning raw materials can only be imported from foreign countries, which has become the main bottleneck restricting the development of China's Lyocell fiber industry. Therefore, extracting widely-sourced, biodegradable polymer materials from renewable agricultural and industrial byproducts, and using these materials as raw materials to develop high-performance, low-cost new Lyocell fibers has become an urgent task for researchers in the synthetic fiber field.

The brewing industry of China has a long history. Taking yellow wine, which originated from and is unique to China, as an example, according to the data from the National Bureau of Statistics cited by the China Alcoholic Drinks Association, in 2020, although the alcohol market was significantly impacted by the COVID-19 pandemic, the yellow wine production of China still reached 1.8571 million kiloliters. Based on the approximate ratio that brewing 1 kg of yellow wine produces approximately 6 kg of distillers grains, the yellow wine industry of China alone produces more than 10 million tons of distillers grains annually. Due to the huge output of distillers grains, most breweries still adopt traditional methods like landfill or incineration for treatment. The landfill treatment occupies a large area, and it will harm the soil if buried too deep. Although the incineration treatment can effectively reduce the accumulation of spent distillers grains, the gases released during burning contain large amounts of sulfides and nitrogen oxides due to the complex components in distillers grains, severely polluting the atmospheric environment. In recent years, although researchers have used distillers grains for animal feed, anaerobic digestion, and fermentation to produce ethanol fuel, the amount of distillers grains consumed by these applications accounts for only a small fraction of the annual distillers grains waste, and a large amount of distillers grains still awaits treatment. The volume reduction, detoxification, and resource utilization of spent distillers grains have become an important topic concerning ecological civilization, environmental protection and new material development.

Due to the presence of abundant cellulose, a polymer suitable for wet spinning, along with skin-beneficial compounds including amino acids such as lysine and methionine and vitamins B and E in distillers grains, with these substances accounting for approximately 20% of the dry weight of distillers grains, the conventional practice of treating distillers grains as industrial solid waste has evidently resulted in significant resource wastage. To date, there have been no domestic or international reports on utilizing distillers grains for the production of high-purity, high-value cellulose pulp for Lyocell fiber preparation.

Currently, there are some published literature about extracting cellulose from distillers grains; for example, a patent publication CN102356882A disclosed a method for producing biodietary cellulose using beer distillers grains, where the method involves grinding beer distillers grains with water into pulp, adjusting the pH to 5-6, settling for 20-40 min, filtering to remove solid substances, then adding 5-10 weight percent of protease to the filtrate, maintaining the temperature at 50-70 °C, enzymatic hydrolysis for 1-3 h, adjusting the pH to neutral, filtering again to remove solid substances, sterilizing for use as a culture medium for biodietary cellulose-producing bacteria, then inoculating biodietary cellulose-producing bacteria to ferment and produce biodietary cellulose membrane. Evidently, this patent utilizes the nutrients in beer distillers grains as a culture medium for biodietary cellulose, and then uses the fermentation method to produce biodietary cellulose membrane, rather than isolating high-purity cellulose from beer distillers grains.

A patent publication CN105476031A disclosed a production method of dietary fiber from distillers grains. The method involves the following steps: 1) mixing distillers grains waste with calcium chloride and then settling for flocculation, and filtering to collect the flocculent; 2) calcium removal through acid treatment; 3)alkaline treatment using sodium carbonate; 4) bleaching treatment using hydrogen peroxide; 5) washing to remove the hydrogen peroxide; 6) drying and grinding treatment. Evidently, the distillers grains fiber produced by this process is a mixture of cellulose, hemicellulose and lignin, with its core technology being the treatment of distillers grains using a high-concentration sodium carbonate solution. Since no separation of the mixed products is performed after the treatment by sodium carbonate solution, the obtained dietary fiber product is merely a mixture of cellulose, hemicellulose and lignin.

A patent application CN108149506A disclosed a method for producing high-purity cellulose, hemicellulose and lignin from distillers grains. The main steps of this method include: 1) drying and grinding; 2) using biological enzymes to remove proteins from the distillers grains; 3) treatment with a food-grade organic solvent aqueous solution under high temperature and high pressure (120-250 °C, 450-4000 kPa) to dissolve hemicellulose and lignin, followed by solid-liquid separation to obtain solid cellulose and liquid components; 4) mixing the filtrate with cooling water and settling to precipitate lignin; 5) feeding the remaining liquid into a vacuum distillation apparatus for organic solvent recovery and water evaporation to obtain high-purity hemicellulose.

The method can effectively separate high-purity cellulose, hemicellulose and lignin from distillers grains; however, this method requires the consumption of large amounts of food-grade organic solvents and necessitates high-temperature and high-pressure equipment for production, resulting in high production costs and stringent equipment requirements. The distillers grains waste contains various components including starch, proteins, pectin, lipids, ash, lignin, and hemicellulose, which makes the separation of high-purity cellulose particularly challenging. In existing reports on the resource utilization of distillers grains, the separated cellulose products are mainly used in the food industry, with no documented applications in textile manufacturing.

Therefore, it is necessary to develop a simple and cost-effective method to remove the various impurities from the distillers grains, thereby obtaining a pulp with high-purity and high-quality cellulose, making it better suited to form a spinning solution for the preparation of Lyocell fibers.

### SUMMARY OF THE INVENTION

The inventive disclosure provides a preparation method for distillers grain-based Lyocell fiber pulp. The distillers grain pulp cellulose prepared by the method has a purity of 90% or more, and can be used to prepare Lyocell fiber.

The specific technical solutions are as follows:

A preparation method of distillers grain-based Lyocell fiber pulp, including the following steps:
(1) dilute sulfuric acid treatment: drying, grinding into powder, and screening the distillers grain raw material in sequence to obtain distillers grain powder; using water as a reaction medium to prepare distillers grain powder into a suspension I; under stirring conditions, adding dilute sulfuric acid dropwise to the suspension I, heating to 40-50 °C, filtering after stirring, washing thoroughly with water until neutral, drying to obtain distillers grain powder treated with dilute sulfuric acid;
(2) caustic soda/sodium sulfite treatment: using water as a reaction medium to prepare the distillers grain powder treated with dilute sulfuric acid from step (1) into a suspension II, under stirring conditions, adding a certain amount of caustic soda and sodium sulfite in sequence to the suspension II, heating to 95-100 °C, filtering after stirring, washing thoroughly with water until neutral, drying to obtain distillers grain powder treated with caustic soda/sodium sulfite;
(3) p-toluenesulfonic acid treatment: using water as a reaction medium to prepare the distillers grain powder treated with caustic soda/sodium sulfite from step (2) into a suspension III, under stirring conditions, adding p-toluenesulfonic acid aqueous solution dropwise to the suspension III, heating to 70-80 °C, filtering after stirring, separating the filtrate and residue, washing the residue with water until the washing liquid is neutral, drying the residue to obtain a distillers grain-based Lyocell fiber pulp.

In this inventive disclosure, firstly the distillers grain raw material is pretreated using the dilute sulfuric acid at 40-50 °C, to perform hydrolysis and remove the starch in the distillers grains, and then washed with distilled water until neutral; thereafter, the acid-treated distillers grain is treated with a high temperature treatment of 95-100 °C using a caustic soda/sodium sulfite mixed aqueous solution, to remove protein, pectin, fatty acids (esters), partial lignin, ash and so on from the distillers grains, and then washed with distilled water until neutral; then, the distillers grains treated with the caustic soda/sodium sulfite is treated with 70-80 °C treatment using an easily recyclable organic acid, p-toluenesulfonic acid aqueous solution, to dissolve and remove lignin and hemicellulose in the distillers grains, and then filtered, washed and dried to obtain distillers grain pulp. The distillers grain pulp cellulose produced by the method of the present inventive disclosure has a high purity (≥90%), and has a good solubility in N-methylmorpholine-N-oxide solvent, able to prepare Lyocell fiber by conventional wet spinning methods.

Only the cellulose in the crude fiber (that is, the collective name of cellulose, hemicellulose, and lignin) in the distillers grains is the active ingredient for spinning Lyocell fiber. Step 1) treatment with dilute sulfuric acid to remove starch and step 2) caustic soda/sodium sulfite treatment removes protein, pectin, fatty acids (esters), partial lignin, ash, and so on, in order to remove impurities and obtain crude fiber. If the conditions of steps 1) and 2) are changed, the impurities will not be completely removed, which will increase the burden of p-toluenesulfonic acid on removing lignin and hemicellulose, and will not be conducive to the dissolution and spinning of the pulp in NMMO. Step 2) is similar. If the target impurities are not completely removed, the burden of the p-toluenesulfonic acid on removing lignin and hemicellulose will also increase.

The particle size and mass fraction of distillers grain powder help to improve the reaction efficiency of the sulfuric acid treatment. Further, in step (1), in step (1), the particle size of the distillers grain powder is between 50-300 mesh; calculated on a basis of mass percentage, the mass percentage of distillers grain powder in the suspension I is 10-20%.

Further, in step (1), the mass concentration of the dilute sulfuric acid is 20-30%; the volume ratio of dilute sulfuric acid to water is 1:40-1:50, the operation of the adding dropwise is completed within 10-15 min; the stirring time is 30-60 min. The selection of the above parameters helps to improve the reaction efficiency and reaction uniformity of sulfuric acid treatment.

Further, in step (2), calculated on a basis of mass percentage, the mass percentage of the distillers grain powder treated with the dilute sulfuric acid in the suspension II is 2.5-5.0%.

Further, in step (2), the mass ratio of caustic soda to the distillers grain powder treated with the dilute sulfuric acid is 1:1-1:1.5; the mass ratio of sodium sulfite to the distillers grain powder treated with the dilute sulfuric acid is 1:9-1:12; the time of the stirring is 4-6 h.

Further, in step (3), calculated on a basis of mass percentage, in the suspension III, the mass percentage of the distillers grain powder treated with the caustic soda/sodium sulfite is 5-10%.

In the present inventive disclosure, the types of organic solvents are tested, and it is found that p-toluenesulfonic acid can significantly improve the purity of the distiller s grain cellulose, while its analogue, benzenesulfonic acid, has a relatively poor effect.

Further, in step (3), the mass concentration of the p-toluenesulfonic acid aqueous solution is 20-30%; the volume ratio of p-toluenesulfonic acid aqueous solution to water is 1:6-1:10, the operation of the adding dropwise is completed within 10-15 min; the stirring time is 6-8 h.

The present inventive disclosure also provides a distillers grain-based Lyocell fiber pulp prepared by the preparation method as described above.

Compared with the prior art, the present inventive disclosure has the following beneficial effects:
(1) The present inventive disclosure adopts the treatment process of the dilute sulfuric acid-caustic soda/sodium sulfite-p-toluenesulfonic acid to process the distillers grains, and the obtained distillers grain pulp fiber has a purity of 90% or more.
(2) The present inventive disclosure can complete the separation of cellulose, hemicellulose and lignin in the distillers grains without consuming any organic solvent and no need for high-temperature and high-pressure equipment, thereby reducing production costs and simplifying production equipment.
(3) It is found in the present inventive disclosure that the p-toluenesulfonic acid treatment method avoids the damage to the cellulose structure caused by the high temperature and high pressure environment (120-250 °C, 450-4000 kPa) in the existing methods of removing hemicellulose and lignin from distillers grains. It is beneficial to improve the product properties of distillers grain-based Lyocell fiber (such as mechanical properties and thermal stability).

### BRIEF DESCRIPTION OF THE DRAWINGS

FIG. 1 is a schematic flow chart of the preparation method for distillers grain-based Lyocell fiber pulp of the present inventive disclosure.

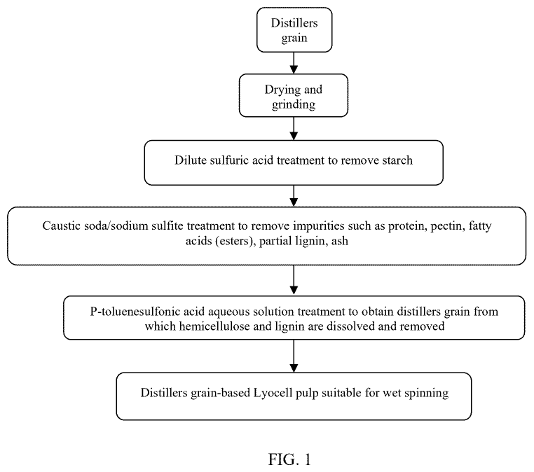

### DETAILED DESCRIPTION OF THE PREFERRED EMBODIMENTS

The present inventive disclosure will be further described below with reference to specific examples. The following are only specific examples of the present inventive disclosure, but the protection scope of the present inventive disclosure is not limited thereto.

The detection methods and specific contents involved in the following embodiments are as follows: Method for determination of crude starch content in raw materials: GB/T 5009.9-2008 Determination of Starch in Food; Method for determination of crude protein content in raw materials: GB/T 5009.5-2010 Determination of Protein in Food; Method for determination of crude fiber content in raw materials: GB/T 5009.88-2003 Determination of Insoluble Dietary Fiber in Food; Method for determination of crude fat content in raw materials: GB/T 5009.6-2010 Determination of Fat in Food; Method for determination of ash content in raw materials: GB/T 5009.4-2010 Determination of Ash in Food; Method for determination of lignin, hemicellulose, and cellulose content in crude fiber: NY/T 3494-2019 Determination of Cellulose, Hemicellulose, Lignin in Agricultural Biomass Raw Materials.

### Example 1

In this example, the distillers grain is sourced from a yellow wine manufacturer in Zhejiang that mainly uses glutinous rice as raw material. The specific preparation method of distillers grain-based Lyocell pulp is as follows:
1) The distillers grain raw material is finely ground in a mortar, passed through a 70-mesh sieve, and dried to absolute dryness in a vacuum drying oven. According to component analysis, the mass percentages of the main components of the dried distillers grain raw material: crude starch, crude protein, crude fiber, crude fat, and ash, are 28.20%, 35.52%, 18.81%, 9.25%, and 3.11%, respectively.

The ground distillers grain powder with a dry weight of 100 g is dispersed in 700 g of distilled water to prepare a suspension with a mass concentration of 12.5%, then transferred to a 2000 mL three-neck flask equipped with mechanical stirring, thermometer, and dropping funnel. Under mechanical stirring conditions, 17.5 mL of 25 wt % dilute sulfuric acid is added dropwise to the suspension within 15 min, heated to 50 °C, stirred at this temperature for 45 min, filtered, thoroughly washed with distilled water until neutral, dried to obtain distillers grain powder treated with the dilute sulfuric acid.

According to component analysis, the mass percentages of the main components of the distillers grain powder treated with the dilute sulfuric acid: crude starch, crude protein, crude fiber, crude fat, and ash, are 1.97%, 54.50%, 26.62%, 12.73%, and 2.81%, respectively.
2) The aforementioned distillers grain powder treated with the dilute sulfuric acid with a dry weight of 50 g is dispersed in 950 g of distilled water to prepare a suspension with a mass concentration of 5%, then transferred to a 2000 mL three-neck flask equipped with mechanical stirring, thermometer, and dropping funnel. Under mechanical stirring conditions, 37.5 g of caustic soda and 4.5 g of sodium sulfite are added to the suspension sequentially, heated to 100 °C, stirred at this temperature for 4 h, filtered, thoroughly washed with distilled water until neutral, and dried to obtain distillers grain powder treated with the caustic soda/sodium sulfite.

According to component analysis, the main components remaining in the distillers grain powder treated with the caustic soda/sodium sulfite is only crude fiber, with a mass percentage of 96.02%.
3) The aforementioned distillers grain powder treated with the caustic soda/sodium sulfite with a dry weight of 25 g is dispersed in 375 mL of distilled water to prepare a suspension with a mass concentration of 6.25%, then transferred to a 1000 mL three-neck flask equipped with mechanical stirring, thermometer, and dropping funnel. Under mechanical stirring conditions, 37.5 mL of 25 wt % p-toluenesulfonic acid aqueous solution is added dropwise to the suspension within 10 min, heated to 80 °C, and stirred at this temperature for 6 h. The filtrate and residue are separated. The residue is washed with distilled water until the washing liquid is neutral, and then the residue is dried to obtain distillers grain-based Lyocell pulp.

### Example 2

Based on Example 1, in this example, the heating temperature in step (3) is modified from 80 °C to 90 °C, while all other contents are maintained identical to Example 1.

Specific step (3) is: The aforementioned distillers grain powder treated with the caustic soda/sodium sulfite with a dry weight of 25 g is dispersed in 375 mL of distilled water to prepare a suspension with a mass concentration of 6.25%. The suspension is transferred to a 1000 mL three-neck flask equipped with mechanical stirring, thermometer, and dropping funnel. Under mechanical stirring conditions, 37.5 mL of 25 wt % p-toluenesulfonic acid aqueous solution is added dropwise to the suspension within 10 min, heated to 90 °C, and stirred at this temperature for 6 h. The filtrate and residue are separated. The residue is washed with distilled water until the washing liquid is neutral, and then the residue is dried to obtain distillers grain-based Lyocell pulp.

### Example 3

Based on Example 1, in this example, the volume of p-toluenesulfonic acid aqueous solution added dropwise to the suspension in step (3) is modified from 37.5 mL to 62.5 mL, while all other contents are maintained identical to Example 1.

Specific step (3) is: The aforementioned distillers grain powder treated with the caustic soda/sodium sulfite with a dry weight of 25 g is dispersed in 375 mL of distilled water to prepare a suspension with a mass concentration of 6.25%. The suspension is transferred to a 1000 mL three-neck flask equipped with mechanical stirring, thermometer, and dropping funnel. Under mechanical stirring conditions, 37.5 mL of 25 wt % p-toluenesulfonic acid aqueous solution is added dropwise to the suspension within 10 min, heated to 80 °C, and stirred at this temperature for 6 h. The filtrate and residue are separated. The residue is washed with distilled water until the washing liquid is neutral, and then the residue is dried to obtain distillers grain-based Lyocell pulp.

### Comparative Example 1

Based on Example 1, in this comparative example, the type of organic acid is modified from p-toluenesulfonic acid to benzenesulfonic acid, while all other contents are maintained identical to Example 1.

Specific step (3) is: The aforementioned distillers grain powder treated with the caustic soda/sodium sulfite with a dry weight of 25 g is dispersed in 375 mL of distilled water to prepare a suspension with a mass concentration of 6.25%. The suspension is transferred to a 1000 mL three-neck flask equipped with mechanical stirring, thermometer, and dropping funnel. Under mechanical stirring conditions, 37.5 mL of 25 wt % benzenesulfonic acid aqueous solution is added dropwise to the suspension within 10 min, heated to 80 °C, and stirred at this temperature for 6 h. The filtrate and residue are separated. The residue is washed with distilled water until the washing liquid is neutral, and then the residue is dried to obtain yellow wine distillers grain pulp.

### Comparative Example 2

Based on Comparative example 1, in this comparative example, the heating temperature in step (3) is modified from 80 °C to 90 °C, while all other contents are maintained identical to Comparative example 1.

Specific step (3) is: The aforementioned distillers grain powder treated with the caustic soda/sodium sulfite with a dry weight of 25 g is dispersed in 375 mL of distilled water to prepare a suspension with a mass concentration of 6.25%. The suspension is transferred to a 1000 mL three-neck flask equipped with mechanical stirring, thermometer, and dropping funnel. Under mechanical stirring conditions, 37.5 mL of 25 wt % benzenesulfonic acid aqueous solution is added dropwise to the suspension within 10 min, heated to 90 °C, and stirred at this temperature for 6 h. The filtrate and residue are separated. The residue is washed with distilled water until the washing liquid is neutral, and then the residue is dried to obtain yellow wine distillers grain pulp.

### Comparative Example 3

Based on Comparative example, in this example, the volume of benzenesulfonic acid aqueous solution added dropwise to the suspension in step (3) is modified from 37.5 mL to 62.5 mL, while all other contents are maintained identical to Comparative example 1.

Specific step (3) is: The aforementioned distillers grain powder treated with the caustic soda/sodium sulfite with a dry weight of 25 g is dispersed in 375 mL of distilled water to prepare a suspension with a mass concentration of 6.25%. The suspension is transferred to a 1000 mL three-neck flask equipped with mechanical stirring, thermometer, and dropping funnel. Under mechanical stirring conditions, 62.5 mL of 25 wt % benzenesulfonic acid aqueous solution is added dropwise to the suspension within 10 min, heated to 80 °C, and stirred at this temperature for 6 h. The filtrate and residue are separated. The residue is washed with distilled water until the washing liquid is neutral, and then the residue is dried to obtain yellow wine distillers grain pulp. The cellulose purities of the yellow wine distillers grain pulp from Examples 1-3 and Comparative Examples 1-3 are tested, and the results are shown in Table 1.

TABLE 1
Cellulose purity of the yellow wine distillers
grain pulp under different treatment processes

| | | Volume ratio | | | Mean square |
|---|---|---|---|---|---|
| | | of organic | | | deviation of |
| | | acid aqueous | Processing | Cellulose | Cellulose |
| | Organic acid | solution to | temperature/ | purity in | purity in |
| Case number | types | distilled water | °C | the pulp/% | the pulp |
| Example 1 | p-toluenesulfonic | 1:10 | 80 | 90.5^{a} | 1.6447 |
| | acid | | | | |
| Example 2 | p-toluenesulfonic | 1:10 | 90 | 91.5 ^{a} | 1.7393 |
| | acid | | | | |
| Example 3 | p-toluenesulfonic | 1:6 | 80 | 92.3 ^{a} | 1.9925 |
| | acid | | | | |
| Comparative | benzenesulfonic | 1:10 | 80 | 85.2 ^{b} | 1.5182 |
| example 1 | acid | | | | |
| Comparative | benzenesulfonic | 1:10 | 90 | 83.8 ^{b} | 1.8028 |
| example 2 | acid | | | | |
| Comparative | benzenesulfonic | 1:6 | 80 | 86.5 ^{b} | 1.4866 |
| example 3 | acid | | | | |

Note:
The cellulose purity test of each type of pulp was repeated 3 times. Data analysis was performed using SAS software with a confidence interval of 95%. A p-value less than 0.05 was considered statistically significant. In Table 1, data points marked with the same lowercase letter are considered not significantly different from each other.

### Example 4

In this example, the distillers grain is sourced from a white wine manufacturer in Hebei that mainly uses corn as raw material. The specific preparation method of distillers grain-based Lyocell pulp is as follows:
1) The distillers grain raw material is finely ground in a mortar, passed through a 60-mesh sieve, and dried to absolute dryness in a vacuum drying oven.

According to component analysis, the mass percentages of the main components of the dried distillers grain raw material: crude starch, crude protein, crude fiber, crude fat, and ash, are 14.02%, 27.49%, 14.74%, 5.20%, and 2.57%, respectively.

The ground distillers grain powder with a dry weight of 100 g is dispersed in 900 g of distilled water to prepare a suspension with a mass concentration of 10%, then transferred to a 2000 mL three-neck flask equipped with mechanical stirring, thermometer, and dropping funnel. Under mechanical stirring conditions, 18 mL of 25 wt % dilute sulfuric acid is added dropwise to the suspension within 15 min, heated to 45 °C, stirred at this temperature for 30 min, filtered, thoroughly washed with distilled water until neutral, dried to obtain distillers grain powder treated with the dilute sulfuric acid.

According to component analysis, the mass percentages of the main components of the distillers grain powder treated with the dilute sulfuric acid: crude starch, crude protein, crude fiber, crude fat, and ash, are 2.71%, 48.75%, 28.58%, 8.99%, and 3.07%, respectively.
2) The aforementioned distillers grain powder treated with the dilute sulfuric acid with a dry weight of 50 g is dispersed in 1000 g of distilled water to prepare a suspension with a mass concentration of 4.76%, then transferred to a 2000 mL three-neck flask equipped with mechanical stirring, thermometer, and dropping funnel. Under mechanical stirring conditions, 50 g of caustic soda and 5.5 g of sodium sulfite are added to the suspension sequentially, heated to 95 °C, stirred at this temperature for 2 h, filtered, thoroughly washed with distilled water until neutral, and dried to obtain distillers grain powder treated with the caustic soda/sodium sulfite.

According to component analysis, the main components remaining in the distillers grain powder treated with the caustic soda/sodium sulfite is only crude fiber, with a mass percentage of 97.58%.
3) The aforementioned distillers grain powder treated with the caustic soda/sodium sulfite with a dry weight of 25 g is dispersed in 400 mL of distilled water to prepare a suspension with a mass concentration of 5.88%, then transferred to a 1000 mL three-neck flask equipped with mechanical stirring, thermometer, and dropping funnel. Under mechanical stirring conditions, 40 mL of 25 wt % p-toluenesulfonic acid aqueous solution is added dropwise to the suspension within 15 min, heated to 80 °C, and stirred at this temperature for 8 h. The filtrate and residue are separated. The residue is washed with distilled water until the washing liquid is neutral, and then the residue is dried to obtain distillers grain-based Lyocell pulp.

### Example 5

Based on Example 4, in this example, the heating temperature in step (3) is modified from 80 °C to 90 °C, while all other contents are maintained identical to Example 4.

Specific step (3) is: The aforementioned distillers grain powder treated with the caustic soda/sodium sulfite with a dry weight of 25 g is dispersed in 400 mL of distilled water to prepare a suspension with a mass concentration of 5.88%. The suspension is transferred to a 1000 mL three-neck flask equipped with mechanical stirring, thermometer, and dropping funnel. Under mechanical stirring conditions, 40 mL of 25 wt % p-toluenesulfonic acid aqueous solution is added dropwise to the suspension within 15 min, heated to 90 °C, and stirred at this temperature for 8 h. The filtrate and residue are separated. The residue is washed with distilled water until the washing liquid is neutral, and then the residue is dried to obtain distillers grain-based Lyocell pulp.

### Example 6

Based on Example 4, in this example, the volume of p-toluenesulfonic acid aqueous solution added dropwise to the suspension in step (3) is modified from 40 mL to 66.7 mL, while all other contents are maintained identical to Example 4.

Specific step (3) is: The aforementioned distillers grain powder treated with the caustic soda/sodium sulfite with a dry weight of 25 g is dispersed in 400 mL of distilled water to prepare a suspension with a mass concentration of 5.88%. The suspension is transferred to a 1000 mL three-neck flask equipped with mechanical stirring, thermometer, and dropping funnel. Under mechanical stirring conditions, 66.7 mL of 25 wt % p-toluenesulfonic acid aqueous solution is added dropwise to the suspension within 15 min, heated to 80 °C, and stirred at this temperature for 8 h. The filtrate and residue are separated. The residue is washed with distilled water until the washing liquid is neutral, and then the residue is dried to obtain distillers grain-based Lyocell pulp.

### Comparative Example 4

Based on Example 4, in this comparative example, the type of organic acid is modified from p-toluenesulfonic acid to benzenesulfonic acid, while all other contents are maintained identical to Example 1.

Specific step (3) is: The aforementioned distillers grain powder treated with the caustic soda/sodium sulfite with a dry weight of 25 g is dispersed in 400 mL of distilled water to prepare a suspension with a mass concentration of 5.88%. The suspension is transferred to a 1000 mL three-neck flask equipped with mechanical stirring, thermometer, and dropping funnel. Under mechanical stirring conditions, 40 mL of 25 wt % benzenesulfonic acid aqueous solution is added dropwise to the suspension within 15 min, heated to 80 °C, and stirred at this temperature for 8 h. The filtrate and residue are separated. The residue is washed with distilled water until the washing liquid is neutral, and then the residue is dried to obtain white wine distillers grain pulp.

### Comparative Example 5

Based on Comparative example 4, in this comparative example, the heating temperature in step (3) is modified from 80 °C to 90 °C, while all other contents are maintained identical to Comparative example 4.

Specific step (3) is: The aforementioned distillers grain powder treated with the caustic soda/sodium sulfite with a dry weight of 25 g is dispersed in 400 mL of distilled water to prepare a suspension with a mass concentration of 5.88%. The suspension is transferred to a 1000 mL three-neck flask equipped with mechanical stirring, thermometer, and dropping funnel. Under mechanical stirring conditions, 40 mL of 25 wt % benzenesulfonic acid aqueous solution is added dropwise to the suspension within 15 min, heated to 90 °C, and stirred at this temperature for 8 h. The filtrate and residue are separated. The residue is washed with distilled water until the washing liquid is neutral, and then the residue is dried to obtain white wine distillers grain pulp.

### Comparative Example 6

Based on Comparative example 4, in this comparative example, the volume of benzenesulfonic acid aqueous solution added dropwise to the suspension in step (3) is modified from 40 mL to 66.7 mL, while all other contents are maintained identical to Comparative example 1.

Specific step (3) is: The aforementioned distillers grain powder treated with the caustic soda/sodium sulfite with a dry weight of 25 g is dispersed in 400 mL of distilled water to prepare a suspension with a mass concentration of 6.25%. The suspension is transferred to a 1000 mL three-neck flask equipped with mechanical stirring, thermometer, and dropping funnel. Under mechanical stirring conditions, 66.7 mL of 25 wt % benzenesulfonic acid aqueous solution is added dropwise to the suspension within 10 min, heated to 80 °C, and stirred at this temperature for 6 h. The filtrate and residue are separated. The residue is washed with distilled water until the washing liquid is neutral, and then the residue is dried to obtain white wine distillers grain pulp. The cellulose purities of the white wine distillers grain pulp from Examples 4-6 and Comparative Examples 4-6 are tested, and the results are shown in Table 2.

TABLE 2
Cellulose purity of the white wine distillers
grain pulp under different treatment processes

| | | Volume ratio | | | Mean square |
|---|---|---|---|---|---|
| | | of organic | | | deviation of |
| | | acid aqueous | Processing | Cellulose | Cellulose |
| | Organic acid | solution to | temperature/ | purity in | purity in |
| Case number | types | distilled water | °C | the pulp/% | the pulp |
| Example 4 | p-toluenesulfonic | 1:10 | 80 | 92.2 ^{a} | 1.9609 |
| | acid | | | | |
| Example 5 | p-toluenesulfonic | 1:10 | 90 | 93.0 ^{a} | 1.8344 |
| | acid | | | | |
| Example 6 | p-toluenesulfonic | 1:6 | 80 | 93.5 ^{a} | 1.8069 |
| | acid | | | | |
| Comparative | benzenesulfonic | 1:10 | 80 | 86.3 ^{b} | 1.3928 |
| example 4 | acid | | | | |
| Comparative | benzenesulfonic | 1:10 | 90 | 84.4 ^{b} | 1.4916 |
| example 5 | acid | | | | |
| Comparative | benzenesulfonic | 1:6 | 80 | 87.1 ^{b} | 1.8125 |
| example 6 | acid | | | | |

Note:
The cellulose purity test of each type of pulp was repeated 3 times. Data analysis was performed using SAS software with a confidence interval of 95%. A p-value less than 0.05 was considered statistically significant. In Table 1, data points marked with the same lowercase letter are considered not significantly different from each other.

### Example 7

In this example, the distillers grain is sourced from a beer manufacturer in Zhejiang that mainly uses barley as raw material. The specific preparation method of distillers grain-based Lyocell pulp is as follows:
1) The distillers grain raw material is finely ground in a mortar, passed through a 50-mesh sieve, and dried to absolute dryness in a vacuum drying oven. According to component analysis, the mass percentages of the main components of the dried distillers grain raw material: crude starch, crude protein, crude fiber, crude fat, and ash, are 13.10%, 28.26%, 15.82%, 6.75%, and 3.34%, respectively. The ground distillers grain powder with a dry weight of 100 g is dispersed in 600 g of distilled water to prepare a suspension with a mass concentration of 14.3%, then transferred to a 2000 mL three-neck flask equipped with mechanical stirring, thermometer, and dropping funnel. Under mechanical stirring conditions, 13 mL of 25 wt % dilute sulfuric acid is added dropwise to the suspension within 10 min, heated to 50 °C, stirred at this temperature for 60 min, filtered, thoroughly washed with distilled water until neutral, dried to obtain distillers grain powder treated with the dilute sulfuric acid. According to component analysis, the mass percentages of the main components of the distillers grain powder treated with the dilute sulfuric acid: crude starch, crude protein, crude fiber, crude fat, and ash, are 0.98%, 50.21%, 27.68%, 9.90%, and 3.62%, respectively.
2) The aforementioned distillers grain powder treated with the dilute sulfuric acid with a dry weight of 50 g is dispersed in 1100 g of distilled water to prepare a suspension with a mass concentration of 4.35%, then transferred to a 2000 mL three-neck flask equipped with mechanical stirring, thermometer, and dropping funnel. Under mechanical stirring conditions, 40 g of caustic soda and 5 g of sodium sulfite are added to the suspension sequentially, heated to 98 °C, stirred at this temperature for 1 h, filtered, thoroughly washed with distilled water until neutral, and dried to obtain distillers grain powder treated with the caustic soda/sodium sulfite. According to component analysis, the main components remaining in the distillers grain powder treated with the caustic soda/sodium sulfite is only crude fiber, with a mass percentage of 96.06%.
3) The aforementioned distillers grain powder treated with the caustic soda/sodium sulfite with a dry weight of 25 g is dispersed in 300 mL of distilled water to prepare a suspension with a mass concentration of 7.69%, then transferred to a 1000 mL three-neck flask equipped with mechanical stirring, thermometer, and dropping funnel. Under mechanical stirring conditions, 30 mL of 25 wt % p-toluenesulfonic acid aqueous solution is added dropwise to the suspension within 10 min, heated to 80 °C, and stirred at this temperature for 7 h. The filtrate and residue are separated. The residue is washed with distilled water until the washing liquid is neutral, and then the residue is dried to obtain distillers grain-based Lyocell pulp.

### Example 8

Based on Example 7, in this example, the heating temperature in step (3) is modified from 80 °C to 90 °C, while all other contents are maintained identical to Example 7.

Specific step (3) is: The aforementioned distillers grain powder treated with the caustic soda/sodium sulfite with a dry weight of 25 g is dispersed in 300 mL of distilled water to prepare a suspension with a mass concentration of 7.69%, then transferred to a 1000 mL three-neck flask equipped with mechanical stirring, thermometer, and dropping funnel. Under mechanical stirring conditions, 30 mL of 25 wt % p-toluenesulfonic acid aqueous solution is added dropwise to the suspension within 10 min, heated to 90 °C, and stirred at this temperature for 7 h. The filtrate and residue are separated. The residue is washed with distilled water until the washing liquid is neutral, and then the residue is dried to obtain distillers grain-based Lyocell pulp.

### Example 9

Based on Example 8, in this example, the volume of p-toluenesulfonic acid aqueous solution added dropwise to the suspension in step (3) is modified from 30 mL to 50 mL, while all other contents are maintained identical to Example 8.

Specific step (3) is: The aforementioned distillers grain powder treated with the caustic soda/sodium sulfite with a dry weight of 25 g is dispersed in 300 mL of distilled water to prepare a suspension with a mass concentration of 7.69%, then transferred to a 1000 mL three-neck flask equipped with mechanical stirring, thermometer, and dropping funnel. Under mechanical stirring conditions, 50 mL of 25 wt % p-toluenesulfonic acid aqueous solution is added dropwise to the suspension within 10 min, heated to 80 °C, and stirred at this temperature for 7 h. The filtrate and residue are separated. The residue is washed with distilled water until the washing liquid is neutral, and then the residue is dried to obtain distillers grain-based Lyocell pulp.

### Comparative Example 7

Based on Example 7, in this comparative example, the type of organic acid is modified from p-toluenesulfonic acid to benzenesulfonic acid, while all other contents are maintained identical to Example 7.

Specific step (3) is: The aforementioned distillers grain powder treated with the caustic soda/sodium sulfite with a dry weight of 25 g is dispersed in 300 mL of distilled water to prepare a suspension with a mass concentration of 7.69%, then transferred to a 1000 mL three-neck flask equipped with mechanical stirring, thermometer, and dropping funnel. Under mechanical stirring conditions, 30 mL of 25 wt % benzenesulfonic acid aqueous solution is added dropwise to the suspension within 10 min, heated to 80 °C, and stirred at this temperature for 7 h. The filtrate and residue are separated. The residue is washed with distilled water until the washing liquid is neutral, and then the residue is dried to obtain distillers grain-based Lyocell pulp.

### Comparative Example 8

Based on Comparative example 7, in this comparative example, the heating temperature in step (3) is modified from 80 °C to 90 °C, while all other contents are maintained identical to Comparative example 7.

Specific step (3) is: The aforementioned distillers grain powder treated with the caustic soda/sodium sulfite with a dry weight of 25 g is dispersed in 300 mL of distilled water to prepare a suspension with a mass concentration of 7.69%, then transferred to a 1000 mL three-neck flask equipped with mechanical stirring, thermometer, and dropping funnel. Under mechanical stirring conditions, 30 mL of 25 wt % benzenesulfonic acid aqueous solution is added dropwise to the suspension within 10 min, heated to 90 °C, and stirred at this temperature for 7 h. The filtrate and residue are separated. The residue is washed with distilled water until the washing liquid is neutral, and then the residue is dried to obtain distillers grain-based Lyocell pulp.

### Comparative Example 9

Based on Comparative example 7, in this comparative example, the volume of benzenesulfonic acid aqueous solution added dropwise to the suspension in step (3) is modified from 30 mL to 50 mL, while all other contents are maintained identical to Comparative example 1.

Specific step (3) is: The aforementioned distillers grain powder treated with the caustic soda/sodium sulfite with a dry weight of 25 g is dispersed in 300 mL of distilled water to prepare a suspension with a mass concentration of 7.69%. The suspension is transferred to a 1000 mL three-neck flask equipped with mechanical stirring, thermometer, and dropping funnel. Under mechanical stirring conditions, 50 mL of 25 wt % benzenesulfonic acid aqueous solution is added dropwise to the suspension within 10 min, heated to 80 °C, and stirred at this temperature for 7 h. The filtrate and residue are separated. The residue is washed with distilled water until the washing liquid is neutral, and then the residue is dried to obtain distillers grain-based Lyocell pulp. The cellulose purities of the yellow wine distillers grain pulp from Examples 7-9 and Comparative Examples 7-9 are tested, and the results are shown in Table 3.

TABLE 3
Cellulose Purity in Beer Distiller's Grain
Under Different Organic Acid Treatment Processes

| | | Volume ratio | | | Mean square |
|---|---|---|---|---|---|
| | | of organic | | | deviation of |
| | | acid aqueous | Processing | Cellulose | Cellulose |
| Sample | Organic acid | solution to | temperature/ | purity in | purity in |
| number | types | distilled water | °C | the pulp/% | the pulp |
| Example 7 | p-toluenesulfonic | 1:10 | 80 | 91.8 ^{a} | 1.8439 |
| | acid | | | | |
| Example 8 | p-toluenesulfonic | 1:10 | 90 | 92.6 ^{a} | 1.3730 |
| | acid | | | | |
| Example 9 | p-toluenesulfonic | 1:6 | 80 | 93.0 ^{a} | 1.6155 |
| | acid | | | | |
| Comparative | benzenesulfonic | 1:10 | 80 | 85.5 ^{b} | 1.8788 |
| example 7 | acid | | | | |
| Comparative | benzenesulfonic | 1:10 | 90 | 83.8 ^{b} | 1.9698 |
| example 8 | acid | | | | |
| Comparative | benzenesulfonic | 1:6 | 80 | 86.2 ^{b} | 1.5133 |
| example 9 | acid | | | | |

Note:
The cellulose purity test of each type of pulp was repeated 3 times. Data analysis was performed using SAS software with a confidence interval of 95%. A p-value less than 0.05 was considered statistically significant. In Table 1, data points marked with the same lowercase letter are considered not significantly different from each other.

1. A preparation method of distillers grain-based Lyocell fiber pulp, characterized in comprising the following steps:
(1) dilute sulfuric acid treatment: drying, grinding into powder, and screening the distillers grain raw material in sequence to obtain distillers grain powder; using water as a reaction medium to prepare distillers grain powder into a suspension I; under stirring conditions, adding dilute sulfuric acid dropwise to the suspension I, heating to 40-50 °C, filtering after stirring, washing thoroughly with water until neutral, drying to obtain distillers grain powder treated with dilute sulfuric acid, wherein the particle size of the distillers grain powder is between 50-300 mesh; calculated on a basis of mass percentage, the mass percentage of distillers grain powder in the suspension I is 10-20%, wherein the mass concentration of the dilute sulfuric acid is 20-30%; the volume ratio of dilute sulfuric acid to water is 1:40-1:50, the operation of the adding dropwise is completed within 10-15 min; the stirring time is 30-60 min;
(2) caustic soda/sodium sulfite treatment: using water as a reaction medium to prepare the distillers grain powder treated with dilute sulfuric acid from step (1) into a suspension II, under stirring conditions, adding a certain amount of caustic soda and sodium sulfite in sequence to the suspension II, heating to 95-100 °C, filtering after stirring, washing thoroughly with water until neutral, drying to obtain distillers grain powder treated with caustic soda/sodium sulfite;
(3) p-toluenesulfonic acid treatment: using water as a reaction medium to prepare the distillers grain powder treated with caustic soda/sodium sulfite from step (2) into a suspension III, under stirring conditions, adding p-toluenesulfonic acid aqueous solution dropwise to the suspension III, heating to 70-80 °C, filtering after stirring, separating the filtrate and residue, washing the residue with water until the washing liquid is neutral, drying the residue to obtain a distillers grain-based Lyocell fiber pulp, wherein calculated on a basis of mass percentage, the mass percentage of the distillers grain powder treated with the caustic soda/sodium sulfite in the suspension Ill is 5-10%, wherein the mass concentration of the p-toluenesulfonic acid aqueous solution is 20-30%; the volume ratio of p-toluenesulfonic acid aqueous solution to water is 1:6-1:10, the operation of the adding dropwise is completed within 10-15 min; the stirring time is 6-8 h.

2. (canceled)

3. (canceled)

4. The preparation method of distillers grain-based Lyocell fiber pulp as claimed in claim 1, characterized in that in step (2), calculated on a basis of mass percentage, the mass percentage of the distillers grain powder treated with the dilute sulfuric acid in the suspension II is 2.5-5.0%.

5. The preparation method of distillers grain-based Lyocell fiber pulp as claimed in claim 1, wherein in step (2), the mass ratio of caustic soda to the distillers grain powder treated with the dilute sulfuric acid is 1:1-1:1.5; the mass ratio of sodium sulfite to the distillers grain powder treated with the dilute sulfuric acid is 1:9-1:12; the time of the stirring is 4-6 h.

6. (canceled)

7. (canceled)

8. A distillers grain-based Lyocell fiber pulp prepared by the preparation method as claimed in claim 1.

9. A distillers grain-based Lyocell fiber pulp prepared by the preparation method as claimed in claim 2.

10. A distillers grain-based Lyocell fiber pulp prepared by the preparation method as claimed in claim 3.
